(19) United States
(12) Patent Application Publication
(10) Pub. No.: US 2008/0012256 A1
(43) Pub. Date: Jan. 17, 2008

(54) Receiving container for a sampler or analyzer

(75) Inventors: Norbert Wandrei, Stuttgart (DE); Ralf Steuerwald, Welzheim (DE)

Correspondence Address: BACON & THOMAS, PLLC, 625 SLATERS LANE, FOURTH FLOOR, ALEXANDRIA, VA, 22314, US

(73) Assignee: Endress + Hauser Conducta Gesellschaft fur Mess- u. Regeltechnik mbH + Co. KG, Gerlingen (DE)

(21) Appl. No.: 11/783,626

(22) Filed: Apr. 11, 2007

(30) Foreign Application Priority Data
Apr. 11, 2006 (DE) 10 2006 017 374.0

(51) Int. Cl. B62B 11/00

(52) U.S. Cl. 280/47.34

(57) ABSTRACT

A receiving container for a sampler or analyzer for accommodating at least one containment for storage of a liquid sample, wherein the receiving container is so embodied that it is positionable in the sampler or analyzer and removable from the sampler, wherein in the lower region of the receiving container at least one transport roller or one transport wheel is provided for transport of the receiving container and wherein in the upper region of the receiving container at least one handle is provided.

The invention relates to a receiving container for a sampler or an analyzer for accommodating at least one containment for storing a quantity of liquid sample.

For continuous monitoring and, on occasion, on-site analysis of liquid samples, usually a sampler is placed in the proximity of the sample taking location. Via an automatic suction and filling mechanism, liquid samples are sucked in by means of a metering pump at predetermined time intervals and filled into sample bottles or sample canisters. For transport and storage, the sample bottles or canisters are arranged in a receiving container. Usually, the receiving container has the form of a bottle pack with one or more carrying handles. This bottle pack should facilitate transport, respectively exchange, of the bottles or canisters in the sampler, respectively in the analyzer.

One-piece bottle packs with carrying handles are known. These distinguish themselves by the fact that the bottles can be arranged very compactly in as small a space as possible. Disadvantageous, however, is the relatively great weight of the bottle pack, or receiving container, when the bottles, or canisters, are filled with the liquid. For reducing the weight and thus facilitating transport, it is additionally known to embody the receiving container as two parts. In this way, the weight of the receiving container is cut in half. This facilitated transport comes, however, at the expense of the compact construction of the sampler. As a result of this, the sampler/analyzer requires a greater space, this being problematic in many applications, e.g. when the sampler is placed in a drain for sampling waste water.

The assignee markets a portable sampler bearing the designation LIQUIPORT 2000. A very advantageous embodiment of this sampler is described in DE 102 52 158 B4. Here, a storage or transport container is presented for a sampler, with the storage container being so embodied that it is provided with a lid for the transport of the sample bottles. In this way, transfer of the sample bottles into a corresponding transport container or into a corresponding bottle pack is avoided and a transport container filled with filled bottles is replaced by a transport container filled with empty bottles. The present invention is well suited for such a sampler with an exchangeable lower part in the form of a receiving container.

An object of the invention is to provide a sampler/analyzer, or a receiving container for a sampler/analyzer, which, despite compact construction, can be transported in simple manner.

The object is achieved by the features that the receiving container is so embodied that it is separable from the sampler or analyzer, or positionable in, and removable from, the sampler, that in the lower region of the receiving container at least one transport roller, or transport wheel, is provided for transport of the receiving container, and that in the upper region of the receiving container at least one handle is provided.

Preferably the handle is a drawbar or a cord. The containment can be at least one bottle or at least one canister.

In an advantageous embodiment, at least one transport roller on, or in the lower region of, the receiving container is mounted in such a manner that the receiving container is movable on the transport roller, as soon as the receiving container is inclined by a predetermined angle to perpendicular.

Additionally provided is that the receiving container has a rectangular form. Of course, it can, however, also have the form of the lower part, as such is described in DE 102 52 158 B4.

In the case of an essentially rectangular receiving container, transport wheels, or transparent rollers, are provided, which are attached, or attachable, on opposite corner regions of the receiving container rearwardly located, as viewed in the direction of motion.

An alternative embodiment provides transport wheels, which are connected, or connectable, in the corner regions of the receiving container.

An advantageous form of embodiment of the receiving container of the invention provides that the transport wheels, or at least a transport roller, is/are connectable to the receiving container, or removable from the receiving container. In this way, should such be required, a positioning of the receiving container in the housing of the sampler is facilitated. The same is also provided with respect to the handle.

The invention will now be explained in greater detail on the basis of the appended drawing, the figures of which show as follows:

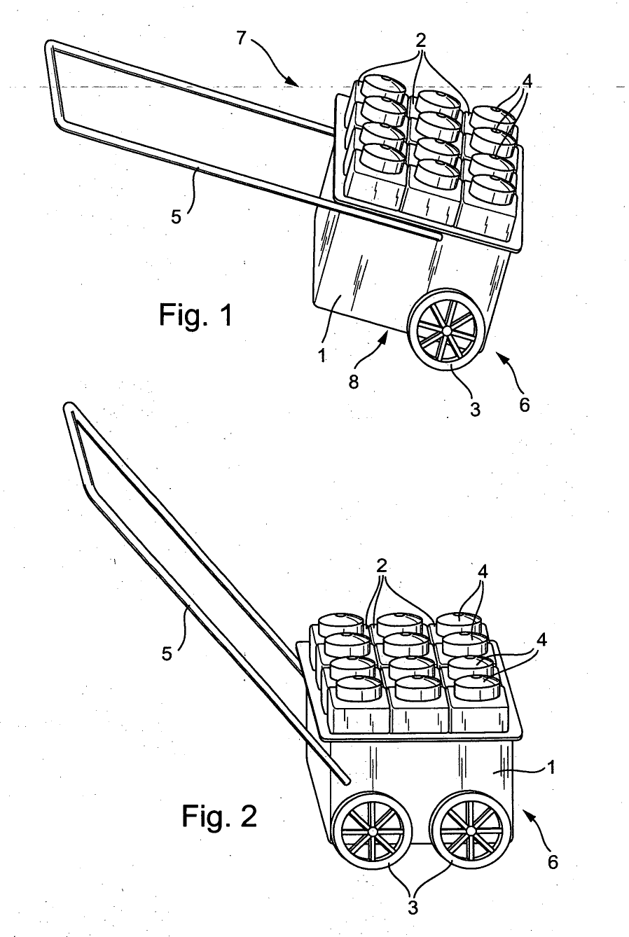

FIG. 1 a perspective view of a first embodiment of the receiving container of the invention; and

FIG. 2 a perspective view of a second embodiment of the receiving container of the invention.

FIG. 1 is a perspective view of a first embodiment of the receiving container of the invention. The receiving container 1 has the form of a rectangular chest, open in the upper region. In the receiving container 1 are stored, in the illustrated case, twelve bottles 2, each closable with a lid 4. For facilitated transport of the bottles 2 filled with sample liquid, the receiving container 1 is embodied so as to be travelable or rollable. For this, depending on direction of movement, the solution of the invention illustrated in FIG. 1 has two transport wheels 3 either behind or in front in the lower region 6 of the receiving container 1. By means of the handle, or grip, 5, which, in the illustrated case is a drawbar, the receiving container 1 is pulled or pushed to a destination.

In the case of the solution of the invention shown in FIG. 2, four transport wheels 3 are provided in the lower region 6 of the receiving container 1. The transport wheels 3 are provided in the four corner regions of the receiving container 1. Preferably, the transport wheels 3 and, in given circumstances, also the drawbar 5 are, as required, adaptable to the receiving container 1. For this, for example, axles carrying the transport wheels 3 are attachable via a corresponding mounting to the underside of the receiving container 1.

1-8. (canceled)

9. A receiving container for a sampler or an analyzer for accommodating at least one containment for storage of a liquid sample, said receiving container having a lower region and a higher region, wherein:
said receiving container is so embodied that it is positionable in the sampler or analyzer and removable from the sampler;
in said lower region of said receiving container at least one transport roller, or transport wheel, is provided for transport of said receiving container; and
in said upper region of said receiving container at least one handle is provided.

10. The receiving container as claimed in claim 9, wherein:
said handle is a drawbar or a cord.

11. The receiving container as claimed in claim 9, wherein:
said at least one transport roller is mounted on said lower region of said receiving container in such a manner that said receiving container is movable on said at least one transport roller, as soon as said receiving container experiences an inclination of a predetermined angle from perpendicular.

12. The receiving container as claimed in claim 9, wherein:
said receiving container has an essentially rectangular form.

13. The receiving container as claimed in claim 9, wherein:
transport wheels or transport rollers are provided, which are mounted or mountable on oppositely lying, back, as seen in the direction of motion, corner regions of said receiving container.

14. The receiving container as claimed in claim 9, wherein:
four transport rollers are provided, which are mounted or mountable in corner regions of said receiving container.

15. The receiving container as claimed in claim 9, wherein:
a mechanism, preferably a clip mechanism, is provided, via which said transport wheels, or said at least one transport roller, are/is mountable to, or removable from said receiving container.

16. The receiving container as claimed in claim 9, wherein:
the containment includes at least one bottle or at least one canister.
